(19) United States
(12) Patent Application Publication
(10) Pub. No.: US 2010/0278423 A1
(43) Pub. Date: Nov. 4, 2010

(54) METHODS AND SYSTEMS FOR CONTRAST ENHANCEMENT

(76) Inventors: Yuji Itoh, Tsukuba (JP); Emi Arai, Tsukuba (JP)

Correspondence Address: TEXAS INSTRUMENTS INCORPORATED, P O BOX 655474, M/S 3999, DALLAS, TX, 75265, US

(21) Appl. No.: 12/433,887

(22) Filed: Apr. 30, 2009

(51) Int. Cl. G06K 9/40; G06K 9/00

(52) U.S. Cl. 382/169; 382/274

(57) ABSTRACT

Methods for contrast enhancement of digital images are provided. A method of adaptive histogram equalization is provided that determines weighting factors for discriminating between sub-regions of a digital image to be more enhanced or less enhanced. Another method for content adaptive local histogram equalization is provided that uses a mapping function in which the dynamic range is not changed by the transformation. A third method for contrast enhancement is provided that includes dividing a digital image into a plurality of regions of pixels, and for each region in the plurality of regions, determining a threshold gray level for the region, generating a mapping curve for the region based on the threshold gray level, and applying the generated mapping curve to each pixel in the region to enhance contrast.

### BACKGROUND OF THE INVENTION

Imaging and video capabilities have become the trend in consumer electronics. Digital cameras, digital camcorders, and video cellular phones are common, and many other new gadgets are evolving in the market. Advances in large resolution CCD/CMOS sensors coupled with the availability of low-power digital signal processors (DSPs) has led to the development of digital cameras with both high resolution image and short audio/visual clip capabilities. The high resolution (e.g., sensor with a 2560×1920 pixel array) provides quality offered by traditional film cameras.

As the camera sensor and signal processing technologies advanced, the nominal performance indicators of camera performance, e.g., picture size, zooming, and range, reached saturation in the market. Then, end users shifted their focus back to actual or perceivable picture quality. The criteria of users in judging picture quality include signal to noise ratio (SNR) (especially in dark regions), blur due to hand shake, blur due to fast moving objects, natural tone, natural color, etc.

Research efforts in tone related issues have been focused on contrast enhancement (CE), which is further classified into global CE and local CE. More particularly, techniques for global CE and local CE are realized by global histogram equalization (global HE or HE) and local histogram equalization (local HE or LHE), respectively. The histogram of an image, i.e., the pixel value distribution of an image, represents the relative frequency of occurrence of gray levels within the image. Histogram modification techniques modify an image so that its histogram has a desired shape. This is useful in stretching the low-contrast levels of an image with a narrow histogram. Global histogram equalization is designed to re-map input gray levels into output gray levels so that the output image has flat occurrence probability (i.e., a uniform probability density function) at each gray level, thereby achieving contrast enhancement. The use of global HE can provide better detail in photographs that are over or under-exposed. However, such plain histogram equalization cannot always be directly applied because the resulting output image is excessively enhanced (over-enhancement) or insufficiently enhanced (under-enhancement).

Local histogram equalization (LHE) may be applied to alleviate some of the issues of global HE. In general, LHE enhances details over small areas (i.e., areas whose total pixel contribution to the total number of image pixels has a negligible influence on the global transform), which adjusts contrast on the basis of a local neighborhood, e.g., a block or sub-region, instead of the entire image. This approach helps with the under-enhancement issue. Tests have shown that applying both global HE and local HE outperforms the use of global HE alone in almost all cases. However, the over-enhancement still remains unsolved by the LHE because it tends to amplify undesired data (i.e., data in regions of less interest) as well as usable data (i.e., data in regions of interest).

However, the application of LHE consumes a lot of memory and processing resources, e.g., construction of a tone curve, memory buffer to calculate the histogram data, memory buffer to store the tone curve, etc. The total resource consumption of LHE is much larger than global HE since the local HE is performed on a region basis (even pixel wise in an extreme case) while global HE is done once per picture. In resource constrained embedded devices with digital image capture capability such as digital cameras, cell phones, etc., using current techniques for both global HE and LHE may not be possible. Accordingly, improvements in contrast enhancement techniques to improve image quality in resource constrained embedded devices are desirable.

### SUMMARY OF THE INVENTION

In general, in one aspect, the invention relates to a method for contrast enhancement of a digital image. The method includes dividing a region of pixels in the digital image into a plurality of sub-regions, determining a weighting factor for each sub-region of the plurality of sub-regions, generating an accumulated normalized histogram of gray level counts in the region wherein for each sub-region, the weighting factor for the sub-region is applied to gray level counts in the sub-region, and applying a mapping function based on the accumulated normalized histogram to the pixels in the region to enhance contrast, wherein the mapping function produces an equalized gray level for each pixel in the region.

In general, in one aspect, the invention relates to a method for contrast enhancement of a digital image. The method includes dividing a region of pixels in the digital image into a plurality of sub-regions, generating an accumulated normalized histogram of gray level counts for a sub-region, and applying a first mapping function based on the accumulated normalized histogram to the pixels in the sub-region to enhance contrast, wherein the first mapping function changes a gray level of a pixel only when the gray level is between or equal to a maximum gray level and a minimum gray level, wherein the maximum gray level and the minimum gray level are one selected from a group consisting of a maximum gray level of the sub-region and a minimum gray level of the sub-region, and a weighted average of the maximum gray level of the sub-region and maximum gray levels of neighboring sub-regions and a weighted average of the minimum gray level of the sub-region and minimum gray levels of neighboring sub-regions.

In general, in one aspect, the invention relates to a method for contrast enhancement of a digital image. The method includes dividing the digital image into a plurality of regions of pixels, and for each region in the plurality of regions, determining a threshold gray level for the region, generating a mapping curve M(x) for the region based on the threshold gray level, and applying the generated mapping curve to each pixel in the region to enhance contrast.

### BRIEF DESCRIPTION OF THE DRAWINGS

Particular embodiments in accordance with the invention will now be described, by way of example only, and with reference to the accompanying drawings:

FIG. 1 shows a digital system in accordance with one or more embodiments of the invention;

FIG. 2 shows a block diagram of an image processing pipeline in accordance with one or more embodiments of the invention;

FIG. 3 shows test images used for experiments in accordance with one or more embodiments of the invention;

FIGS. 4A-4E show experiment results in accordance with one or more embodiments of the invention;

FIGS. 5A, 5B, 6, and 7 show examples in accordance with one or more embodiments of the invention;

FIG. 8 shows a test image used for experiments in accordance with one or more embodiments of the invention;

FIGS. 9A-9D show experiment results in accordance with one or more embodiments of the invention;

FIG. 10 shows a block diagram of a method for contrast enhancement in accordance with one or more embodiments of the invention;

FIGS. 11, 12, and 13 show mapping curves in accordance with one or more embodiments of the invention;

FIG. 14 shows a test image used for experiments in accordance with one or more embodiments of the invention;

FIGS. 15A-15E show experiment results in accordance with one or more embodiments of the invention; and

FIG. 16 shows an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, while the methods are described in relation to application to gray scale, one of ordinary skill in the art will understand that the methods are also applicable to color images by applying the methods separately to each color channel.

In general, embodiments of the invention provide methods, digital systems, and computer readable media that provide improved contrast enhancement (CE) in captured digital images. In one or more embodiments of the invention, a method for content adaptive histogram equalization employs local significance metrics for discriminating between desired and undesired regions of a digital image (i.e., regions to be more enhanced or less enhanced). More specifically, weighting factors are used that are based on local statistics that represent the significance of regions. In one or more embodiments of the invention, a method for content adaptive local histogram equalization employs an activity of image metric based on a first-order derivative to discriminate between regions to be more enhanced and regions to be less enhanced. In one or more embodiments of the invention, a method for local contrast enhancement is provided that has low resource consumption and does not require histogram equalization. More specifically, in embodiments of the method, a mapping curve is synthesized based on local statistics. Regional pixels are classified into two groups: brighter pixels and darker pixels, and then the gray values of the brighter pixels are increased and the gray values of the darker pixels are decreased to provide contrast enhancement.

Embodiments of the methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

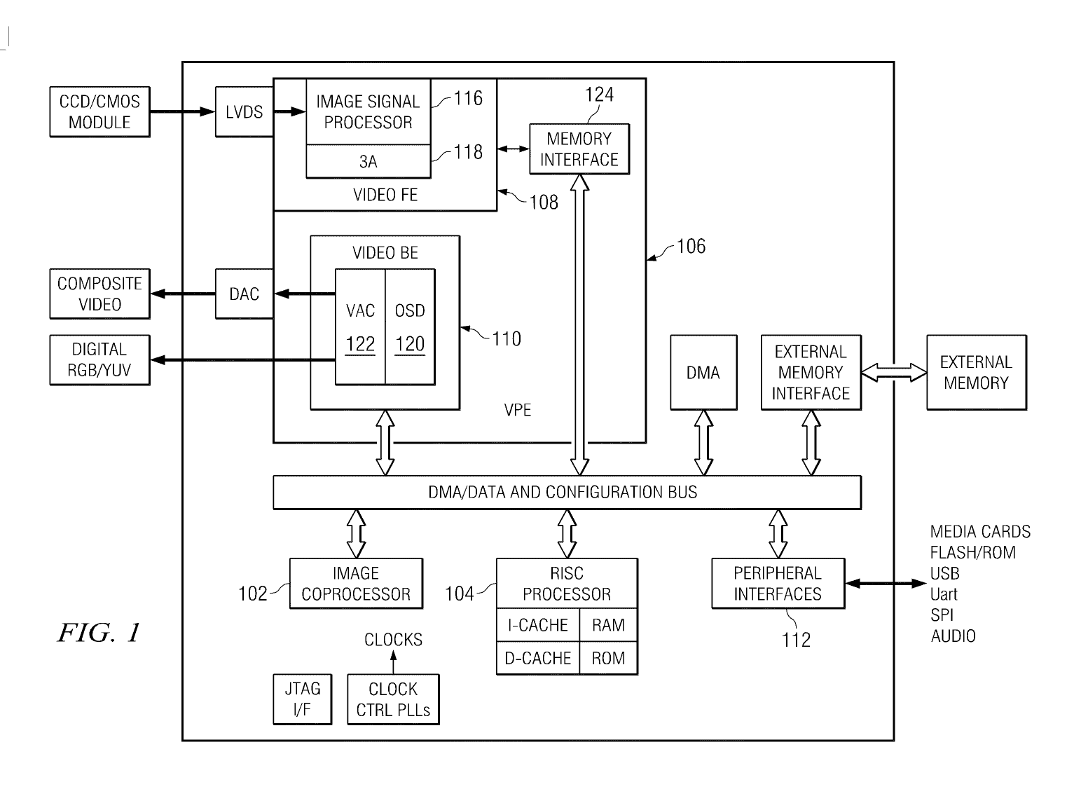

FIG. 1 shows a digital system suitable for an embedded system in accordance with one or more embodiments of the invention that includes, among other components, a DSP-based image coprocessor (ICP) (102), a RISC processor (104), and a video processing engine (VPE) (106) that may be configured to perform the motion estimation methods described herein. The RISC processor (104) may be any suitably configured RISC processor. The VPE (106) includes a configurable video processing front-end (Video FE) (108) input interface used for video capture from imaging peripherals such as image sensors, video decoders, etc., a configurable video processing back-end (Video BE) (110) output interface used for display devices such as SDTV displays, digital LCD panels, HDTV video encoders, etc, and memory interface (124) shared by the Video FE (108) and the Video BE (110). The digital system also includes peripheral interfaces (112) for various peripherals that may include a multi-media card, an audio serial port, a Universal Serial Bus (USB) controller, a serial port interface, etc.

The Video FE (108) includes an image signal processor (ISP) (116), and a 3A statistic generator (3A) (118). The ISP (116) provides an interface to image sensors and digital video sources. More specifically, the ISP (116) may accept raw image/video data from a sensor (CMOS or CCD) and can accept YUV video data in numerous formats. The ISP (116) also includes a parameterized image processing module with functionality to generate image data in a color format (e.g., RGB) from raw CCD/CMOS data. The ISP (116) is customizable for each sensor type and supports video frame rates for preview displays of captured digital images and for video recording modes. The ISP (116) also includes, among other functionality, an image resizer, statistics collection functionality, and a boundary signal calculator. The 3A module (118) includes functionality to support control loops for auto focus, auto white balance, and auto exposure by collecting metrics on the raw image data from the ISP (116) or external memory. In one or more embodiments of the invention, the Video FE (108) is configured to perform at least one of the methods for contrast enhancement as described herein.

The Video BE (110) includes an on-screen display engine (OSD) (120) and a video analog encoder (VAC) (122). The OSD engine (120) includes functionality to manage display data in various formats for several different types of hardware display windows and it also handles gathering and blending of video data and display/bitmap data into a single display window before providing the data to the VAC (122) in YCbCr format. The VAC (122) includes functionality to take the display frame from the OSD engine (120) and format it into the desired output format and output signals required to interface to display devices. The VAC (122) may interface to composite NTSC/PAL video devices, S-Video devices, digital LCD devices, high-definition video encoders, DVI/HDMI devices, etc.

The memory interface (124) functions as the primary source and sink to modules in the Video FE (108) and the Video BE (110) that are requesting and/or transferring data to/from external memory. The memory interface (124) includes read and write buffers and arbitration logic.

The ICP (102) includes functionality to perform the computational operations required for compression and other processing of captured images. The video compression standards supported may include one or more of the JPEG standards, the MPEG standards, and the H.26x standards. In one or more embodiments of the invention, the ICP (102) is configured to perform the computational operations of the methods for contrast enhancement as described herein.

In operation, to capture an image or video sequence, video signals are received by the video FE (108) and converted to the input format needed to perform video compression. Prior to the compression, one of the methods for adaptive equalization or local contrast enhancement may be applied as part of processing the captured video data. The video data generated by the video FE (108) is stored in the external memory. The video data is then encoded, i.e., compressed. During the compression process, the video data is read from the external memory and the compression computations on this video data are performed by the ICP (102). The resulting compressed video data is stored in the external memory. The compressed video data is then read from the external memory, decoded, and post-processed by the video BE (110) to display the image/video sequence.

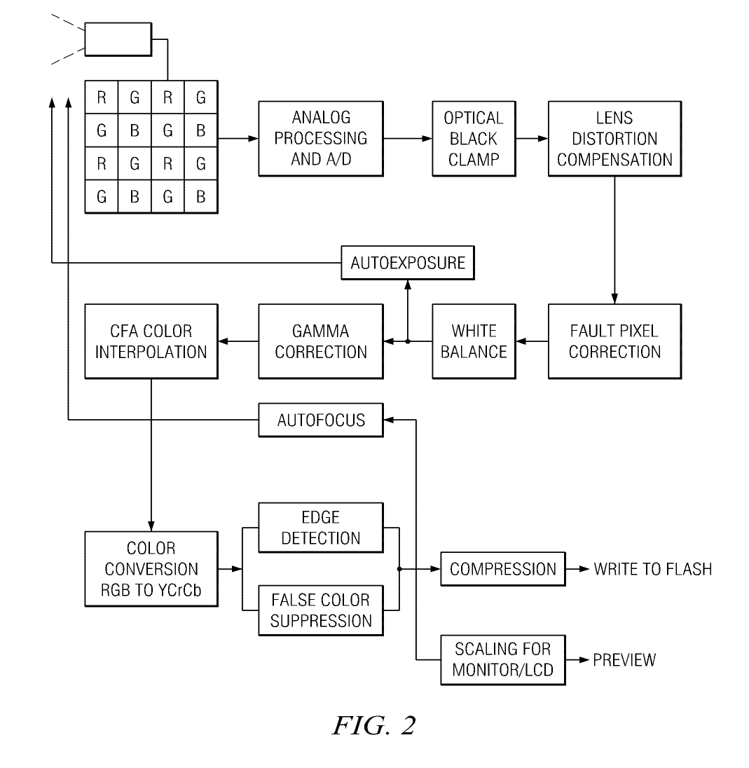

FIG. 2 is a block diagram illustrating digital camera control and image processing (the “image pipeline”) in accordance with one or more embodiments of the invention. One of ordinary skill in the art will understand that similar functionality may also be present in other digital devices (e.g., a cell phone, PDA, etc.) capable of capturing digital images and/or digital video sequences. The automatic focus, automatic exposure, and automatic white balancing are referred to as the 3A functions; and the image processing includes functions such as color filter array (CFA) interpolation, gamma correction, white balancing, color space conversion, and compression/decompression (e.g., JPEG for single images and MPEG for video clips). A brief description of the function of each block in accordance with one or more embodiments is provided below. Note that the typical color CCD consists of a rectangular array of photosites (pixels) with each photosite covered by a filter (the CFA): typically, red, green, or blue. In the commonly-used Bayer pattern CFA, one-half of the photosites are green, one-quarter are red, and one-quarter are blue.

To optimize the dynamic range of the pixel values represented by the CCD imager of the digital camera, the pixels representing black need to be corrected since the CCD cell still records some non-zero current at these pixel locations. The black clamp function adjusts for this difference by subtracting an offset from each pixel value, but clamping/clipping to zero to avoid a negative result.

Imperfections in the digital camera lens introduce nonlinearities in the brightness of the image. These nonlinearities reduce the brightness from the center of the image to the border of the image. The lens distortion compensation function compensates for the lens by adjusting the brightness of each pixel depending on its spatial location.

CCD arrays having large numbers of pixels may have defective pixels. The fault pixel correction function interpolates the missing pixels with an interpolation scheme to provide the rest of the image processing data values at each pixel location.

The illumination during the recording of a scene is different from the illumination when viewing a picture. This results in a different color appearance that is typically seen as the bluish appearance of a face or the reddish appearance of the sky. Also, the sensitivity of each color channel varies such that grey or neutral colors are not represented correctly. The white balance function compensates for these imbalances in colors by computing the average brightness of each color component and by determining a scaling factor for each color component. Since the illuminants are unknown, a frequently used technique just balances the energy of the three colors. This equal energy approach requires an estimate of the unbalance between the color components.

Due to the nature of a color filter array, at any given pixel location, there is only information regarding one color (R, G, or B in the case of a Bayer pattern). However, the image pipeline needs full color resolution (R, G, and B) at each pixel in the image. The CFA color interpolation function reconstructs the two missing pixel colors by interpolating the neighboring pixels.

Display devices used for image-viewing and printers used for image hardcopy have a nonlinear mapping between the image gray value and the actual displayed pixel intensities. The gamma correction function (also referred to as adaptive gamma correction, tone correction, tone adjustment, contrast/brightness correction, etc.) compensates for the differences between the images generated by the CCD sensor and the image displayed on a monitor or printed into a page.

Typical image-compression algorithms such as JPEG operate on the YCbCr color space. The color space conversion function transforms the image from an RGB color space to a YCbCr color space. This conversion is a linear transformation of each Y, Cb, and Cr value as a weighted sum of the R, G, and B values at that pixel location.

The nature of CFA interpolation filters introduces a low-pass filter that smoothes the edges in the image. To sharpen the images, the edge detection function computes the edge magnitude in the Y channel at each pixel. The edge magnitude is then scaled and added to the original luminance (Y) image to enhance the sharpness of the image.

Edge enhancement is only performed in the Y channel of the image. This leads to misalignment in the color channels at the edges, resulting in rainbow-like artifacts. The false color suppression function suppresses the color components, Cb and Cr, at the edges reduces these artifacts.

The autofocus function automatically adjusts the lens focus in a digital camera through image processing. These autofocus mechanisms operate in a feedback loop. They perform image processing to detect the quality of lens focus and move the lens motor iteratively until the image comes sharply into focus.

Due to varying scene brightness, to get a good overall image quality, it is necessary to control the exposure of the CCD. The autoexposure function senses the average scene brightness and appropriately adjusting the CCD exposure time and/or gain. Similar to autofocus, this operation is also in a closed-loop feedback fashion.

Most digital cameras are limited in the amount of memory available on the camera; hence, the image compression function is employed to reduce the memory requirements of captured images and to reduce transfer time. Typically, compression ratios of about 10:1 to 15:1 are used.

In one or more embodiments of the invention, the methods for contrast enhancement as described herein may be performed as part of the gamma correction function. Further, in one or more embodiments of the invention, the methods for contrast enhancement as described herein may be performed somewhere between CFA color interpolation and compression.

Each of the methods for contrast enhancement are now described in more detail under the headings of adaptive histogram equalization based on local significance metrics, adaptive local histogram equalization with activity factor, and local contrast enhancement with low resource consumption.

### Adaptive Histogram Equalization Based on Local Significance Metrics

Embodiments of the method provide for adaptive histogram equalization that uses local significance metrics, i.e., weighting factors, to discriminate between desired data in an image to be more enhanced and undesired data in an image to be less enhanced. In plain histogram equalization, the probability pᵢ of an occurrence of a pixel of gray level i in a discrete grayscale image is given by

$${p}_{i} = \frac{{n}_{i}}{n} , i ∈ 0 , 1 , … , {2}^{β} - 1 \qquad ( 1 )$$

where nᵢ is the number of occurrences of gray level i, where i takes integer values between 0 and 2^{β}−1 (assuming β bits per pixel), 2^{β} denotes the total number of gray levels, i.e., the dynamic range or gray scale resolution of the image, in the image, n denotes the total number of pixels in the image, and p is the histogram of the image, normalized to 0.1. A gray level or gray value is the magnitude of the brightness of a pixel in a color plane in a color image or in the monochrome plan for a monochrome image. P is the cumulative distribution function corresponding to p and is defined by:

$${P}_{x} = {\sum }_{i = 0}^{x} {p}_{i} \qquad ( 2 )$$

which is also known as the accumulated normalized histogram of the image. A mapping function or transformation is defined of the form y=T(x) that produces a level y for each gray level x in the input image, such that the cumulative probability function of y is linearized across the value range. The transformation is defined by:

y=T(x)=Pₓ·(2^{β}−1) (3)

T maps the input gray levels into the output range 0.2^{β}−1 as Pₓ ranges from 0 up to 1. The above describes histogram equalization on a gray scale image. However it is also applicable to color images by applying the same method separately to each color channel.

Plain histogram equalization does not discriminate between desired data and undesired data in the image. However, adaptive histogram equalization (AHE) approaches may be used that modify the plain histogram equalization with some form of discrimination. In its basic form, AHE involves applying to each pixel a histogram equalization mapping based on the pixels in a region surrounding that pixel (its contextual region, neighborhood, or window), i.e., each pixel is mapped to an intensity proportional to its rank in the pixels surrounding it. One category of such approaches modifies the histogram in a local window. In such AHE approaches, a square window may be used, whose transformation Z is represented in general form as

y=Z(x)=ƒ(x)·Pₓ·(2^{β}−1) (4)

where f(x) denotes a cumulation function, i.e., a function that adds adaptability to the histogram equalization. The definition of f(x) depends of what adaption is desired. Note that the transformation T in equation 3 is a special case of the transformation Z with f(x)=1 for any value of x.

Embodiments of the method introduce local significance metrics, i.e., weighting factors, into adaptive histogram equalization. Embodiments of the method are applied to an image region A (where A can be either the entire image or a part of the image). Initially, the image region A is divided into M sub-regions aⱼ, where j=0, 1, . . . , M−1. Let wⱼ denote the weighting factor of aⱼ, the j-th sub-region in the image region A. Then, the adaptive histogram equalization method is expressed by:

$${p}_{ij} = \frac{{w}_{j} \cdot {n}_{ij}}{{n}_{j}} , i ∈ 0 , 1 , … , {2}^{β} - 1 \\ {P}_{x} = \frac{1}{W} {\sum }_{j = 0}^{M - 1} {\sum }_{i = 0}^{x} {p}_{ij} \\ where W = {\sum }_{j = 0}^{M - 1} {w}_{j} \\ y = Z ( x ) = {P}_{x} \cdot ( {2}^{β} - 1 ) \qquad ( 5 )$$

where pᵢⱼ is the probability of a pixel of gray level i in the j-th sub-region, nᵢⱼ is the number of occurrences of the gray level i in j-th sub-region, nⱼ is the total number of pixels in the j-th sub-region, x is the gray level, and P is the cumulative distribution function (i.e., accumulated normalized histogram) corresponding to p. Note that substituting 1/M for wⱼ in every sub-region in the above equation provides the same results as plain histogram equalization.

Different weighting factors wⱼ that relate to how well a sub-region aⱼ contributes to the parent region A may be applied in embodiments of the invention. In one or more embodiments of the invention, the weighting factors are based on a dynamic range given by

wⱼ=maxⱼ−minⱼ (6)

where maxⱼ and minⱼ denote the maximum and minimum gray values (i.e., gray levels), respectively, in the j-th sub-region. In some embodiments of the invention, this dynamic weighting factor may be normalized and given by:

$${w}_{j} = \frac{{max}_{j} {min}_{j}}{{2}^{β}} \qquad {( 6 )}^{′}$$

In one or more embodiments of the invention, the weighting factors are based on the variance of the pixel gray levels. The variance based weighting factor is calculated as:

$${w}_{j} = {V}_{j} = \frac{1}{{n}_{j}} {\sum }_{( s , t ) ∈ j} {k}^{2} ( s , t ) - {\{ \frac{1}{{n}_{j}} {\sum }_{( s , t ) ∈ j} k ( s , t ) \}}^{2} \qquad ( 7 )$$

where k(s,t) denotes the gray level of the pixel located at coordinates (s,t). In some embodiments of the invention, the weighting factor is calculated as the standard deviation of the variance, i.e., is calculated as:

wⱼ=\sqrt{Vⱼ} (8)

In one or more embodiments of the invention, the weighting factors are based on the entropy and are calculated as:

$${w}_{j} = {\sum }_{i = 0}^{{2}^{β} - 1} {p}_{ij} \cdot {log}_{2} \frac{1}{{p}_{ij}} \qquad ( 9 )$$

In some embodiments of the invention, the weighting factors may be normalized to range from zero to one and are calculated as:

$${w}_{j} = \frac{1}{β} {\sum }_{i = 0}^{{2}^{β} - 1} {p}_{ij} \cdot {log}_{2} \frac{1}{{p}_{ij}} \qquad {( 9 )}^{′}$$

In one or more embodiments of the invention, the weighting factors are based on one or more gradients. In some embodiments of the invention, the gradient based weighting factors are calculated as:

$${w}_{j} = {\sum }_{( s , t ) ∈ j} \{ \vert k ( s + 1 , t ) - k ( s , t ) \vert + \vert k ( s , t + 1 ) - k ( s , t ) \vert \} \qquad ( 10 )$$

where k(s,t) denotes the gray level of the pixel located at coordinates (s,t). Note that the above equation calculates the gradient in both the horizontal and vertical directions. In other embodiments of the invention, the weighting factors may be based on only the horizontal gradient, only the vertical gradient, or may be based on the diagonal gradient as well as the horizontal and vertical gradients.

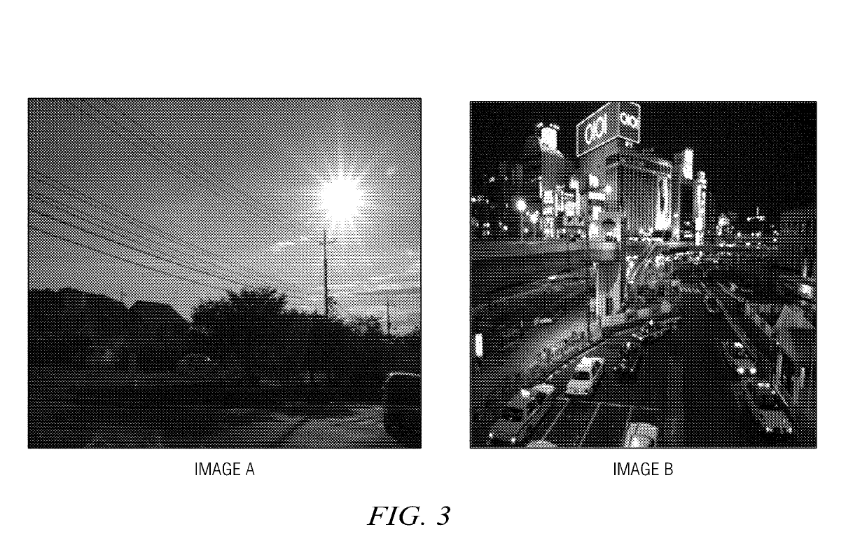

Experiments were performed to assess the performance of embodiments of the method using various of the above weighting factors and the performance of plain histogram equalization. The performance assessment was based on the subjective quality of the resulting images. The assessment focused on how the method with different weighting factors affected the mapping function in comparison to plain histogram equalization, and more specifically on how each weighting factor performed in terms of suppression of over-enhancement and under-enhancement. In these experiments, the sub-region size, i.e., the size of each aⱼ, was set to 64 by 64 pixels. The test images used for the experiments are shown in FIG. 3. Test image A is 720 by 480 pixels and is characterized with backlight, i.e., it was taken against the sun light, which resulted in an irregular histogram in which the objects other than the sun are expressed with insufficient brightness and low contrast. Test image B is 3648 by 2736 pixels and is a nightscape of a town, so that the entire image is dark.

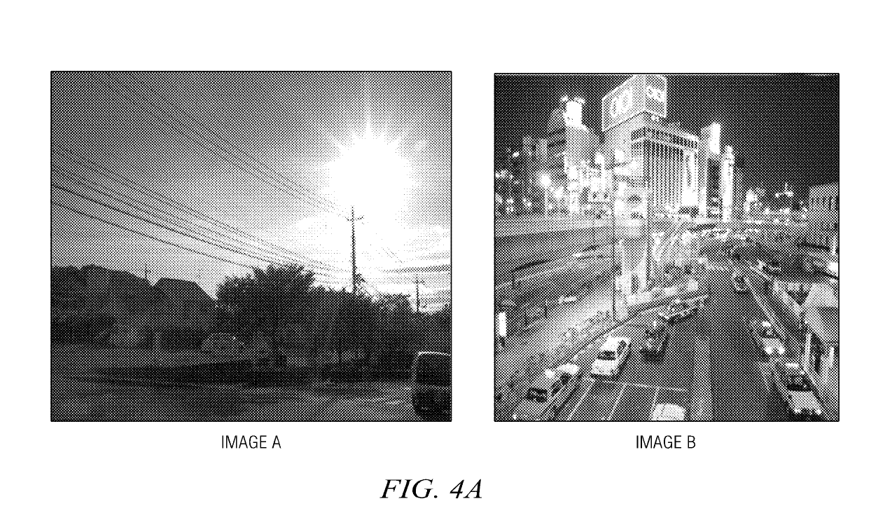

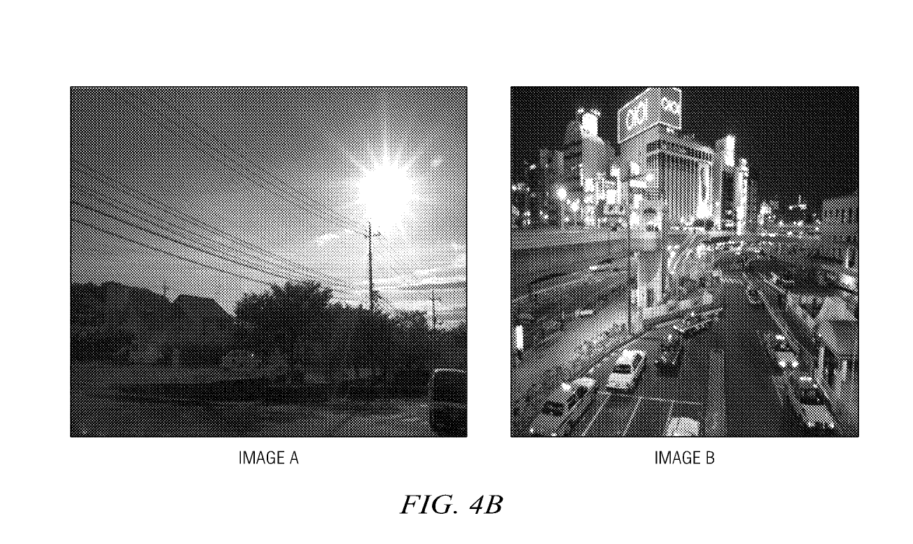

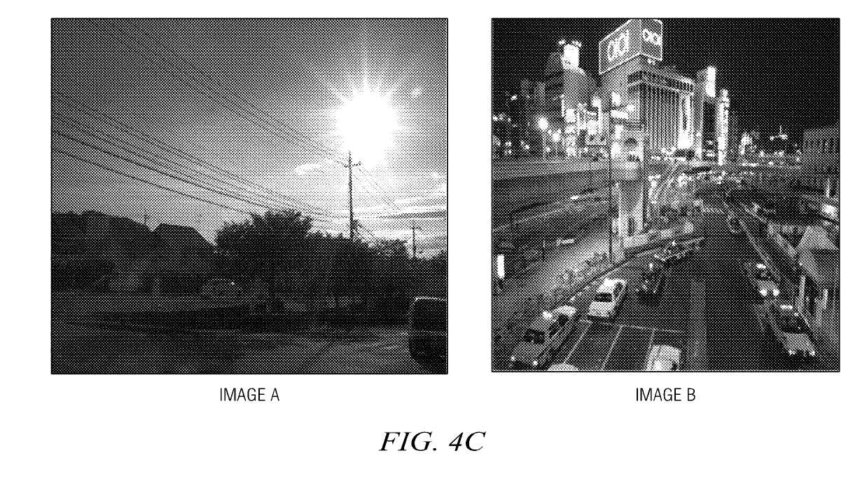

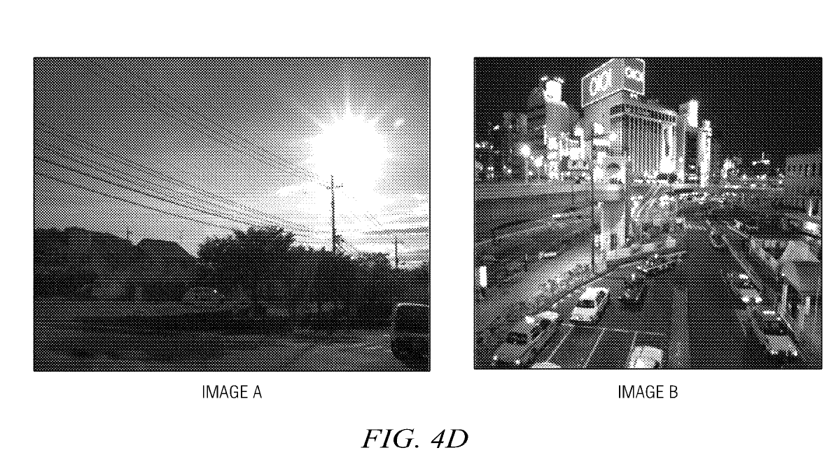

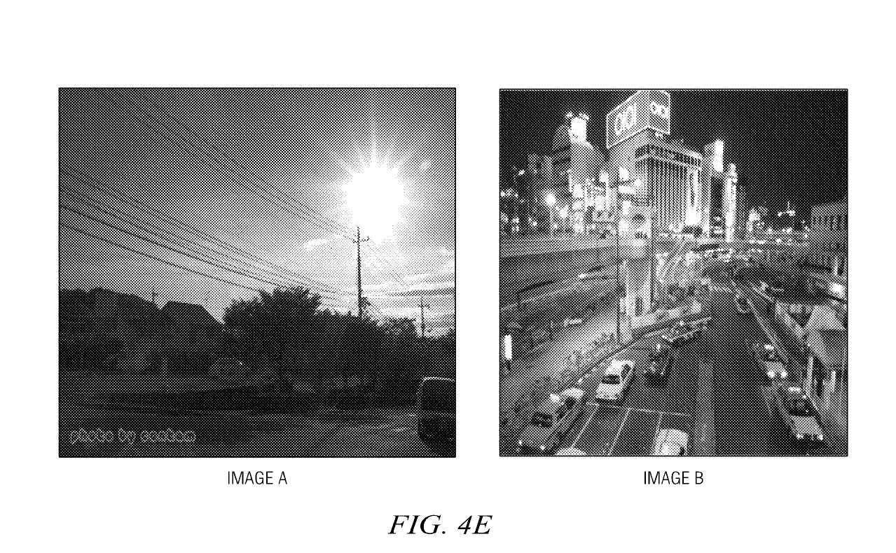

FIG. 4A shows the test images with plain histogram equalization applied. FIGS. 4B-4E show the test images with the method applied using the various weighting factors: dynamic range based weighting factor (FIG. 4B), variance based weighting factor (FIG. 4C), entropy based weighting factor (FIG. 4D) and gradient based weighting factor (FIG. 4E). Overall the resulting images with the application of the plain HE and with the various weighting factors are better than the original test images as the objects can be identified more clearly. For test image A, both the plain HE and various weighting factors provided good brightness control. However, the results with plain HE were less desirable than the various weighting factors with regard to contrast in the bottom part of the image (trees and houses). As for test image B, the application of the plain HE results in over-enhancement in the sky at the right hand side and under-enhancement in the buildings. As shown in FIGS. 4B-4E, although there are subtle differences in the appearance of test image B depending on the weighting factor used, the application of the method with the various weighting factors pertinently suppressed over-enhancement and under-enhancement. Table 1 summarizes these experiment results.

TABLE 1

| | Image A | | Image B | |
|---|---|---|---|---|
| | Suppression | Suppression of | Suppression | Suppression of |
| | of over- | under- | of over- | under- |
| | enhancement | enhancement | enhancement | enhancement |
| Plain HE | | Good brightness | Enhanced | Good brightness |
| | | but low contrast | noise | but low contrast |
| | | at the bottom | undesirably in | around the left-top |
| | | area of image. | the sky area | buildings |
| Dynamic | | Good brightness | Enhanced | Good brightness |
| range based | | and contrast at | noise in the | and contrast around |
| weighting | | the bottom area | sky area | the left-top |
| factor | | of image. | slightly. | buildings. |
| Variance | | Good brightness | No noise | Very good |
| based | | and contrast at | enhancement | brightness and |
| weighting | | the bottom area | in the sky | contrast, especially |
| factor | | of image. | area. | around the left-top |
| | | | | buildings. |
| Entropy | | Good brightness | Enhanced | Good brightness |
| weighting factor | | and contrast at | noise in the | and contrast around |
| | | the bottom area | sky area | the left-top |
| | | of image. | slightly. | buildings. |
| Gradient | | Good brightness | No noise | Very good |
| based | | and contrast at | enhancement | brightness and |
| weighting | | the bottom area | in the sky | contrast, especially |
| factor | | of image. | area. | around the left-top |
| | | | | buildings. |

Adaptive Local Histogram Equalization with Activity Factor

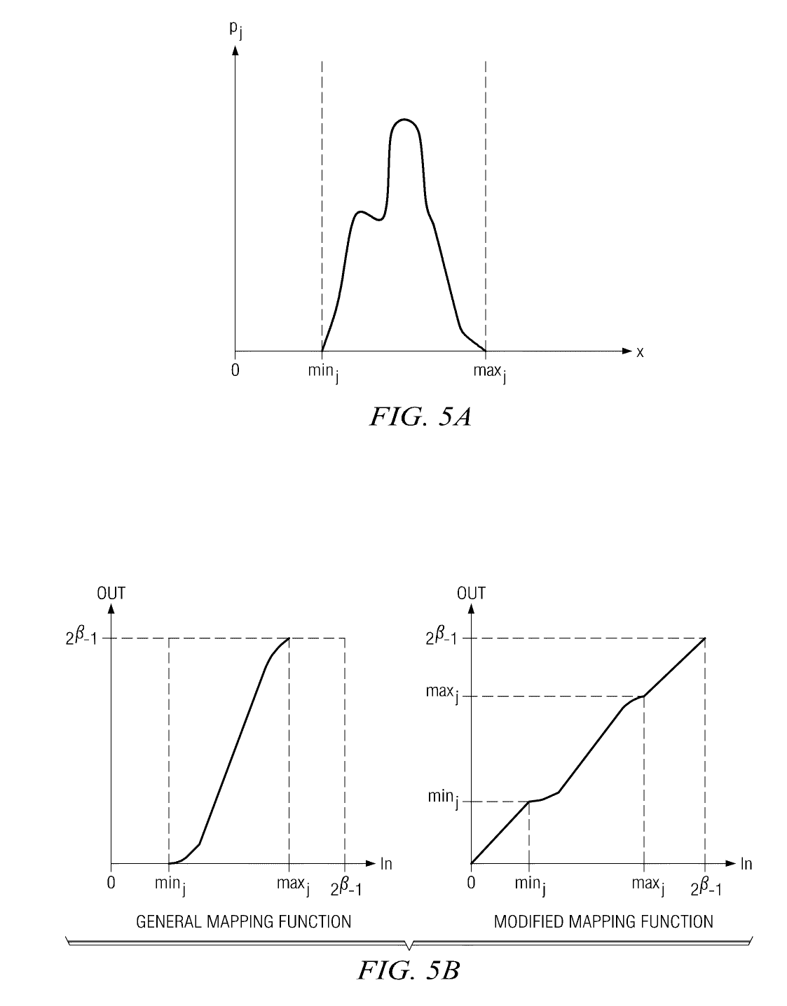

In the histogram equalization of equation 3, the maximum and minimum gray values of the image are mapped to 0 and 2^{β}−1, respectively, which effectively enhances the dynamic range of the image and provides good contrast enhancement. However, in the case of local histogram equalization (LHE), dynamic range enhancement is not necessarily desirable for at least two reasons. First, it is highly possible that the distance between the maximum and minimum gray values is narrow which would cause over-enhancement of the dynamic range. Second, it is possible that the enhancement level of one sub-region widely differs from that of neighboring sub-regions which causes an unnatural boundary between sub-regions. Consequently, in one or more embodiments of the invention, a method for adaptive local histogram equalization uses a mapping function in which the dynamic range is not changed by the transformation. This mapping function is expressed by:

$${y}_{j} = {T}_{j} ( x ) = \{ \begin{matrix}x & if x < {min}_{j} or {max}_{j} < x \\ f ( x ) \cdot {P}_{jx} \cdot {( {max}_{j} - {min}_{j} )}_{+} {min}_{j} & if {min}_{j} <= x <= {max}_{j}\end{matrix} \\ where {P}_{jx} = {\sum }_{i = 0}^{x} {p}_{ij} \qquad ( 11 )$$

where j denotes the index of a sub-region, f(x) is an arbitrary cumulation function, and minⱼ and maxⱼ denote the maximum and minimum gray values in the j-th sub-region, respectively. FIG. 5A shows an example of a local histogram of the j-th sub-block and FIG. 5B shows examples of the general mapping function of equation 3 and modified mapping function of equation 11.

In some embodiments of the invention, maxⱼ and minⱼ are replaced by the weighted average of the maximum and minimum gray values in the neighboring sub-regions to suppress the difference in contrast enhancement levels between sub-regions. This mapping function is expressed by:

$${y}_{j} = {T}_{j} ( x ) = \{ \begin{matrix}x & if x < \overline{{min}_{j}} or \overline{{max}_{j}} < x \\ f ( x ) \cdot {P}_{jx} \cdot ( \overline{{max}_{j}} - \overline{{min}_{j}} ) + \overline{{min}_{j}} & if \overline{{min}_{j}} <= x <= \overline{{max}_{j}}\end{matrix} \qquad ( 12 )$$

where m̅i̅n̅ⱼ̅ and m̅a̅x̅ⱼ̅ denote the weighted average of minⱼ and maxⱼ in the neighboring sub-regions. The weighted averages are calculated by:

$$\overline{{min}_{j}} = \frac{1}{Nt} {\sum }_{j ∈ N} {min}_{j} \cdot {w}_{j} , \overline{{max}_{j}} = \frac{1}{Nt} {\sum }_{j ∈ N} {max}_{j} \cdot {w}_{j} \qquad ( 13 )$$

where N is the sub-region number of neighboring and current sub-regions, Nt is the total number of neighboring sub-regions used for the summation, and wⱼ is the weighting factor. A neighboring sub-region of a sub-region is a sub-region in the region that is immediately above, below, to the upper right or upper left, or lower right or lower left of the sub-region. In one or more embodiments of the invention, the weighting factors may be selected by a user and/or may be preset to default values. In one or more embodiments of the invention, each wⱼ is 1, i.e., the average of the gray level values is not weighted.

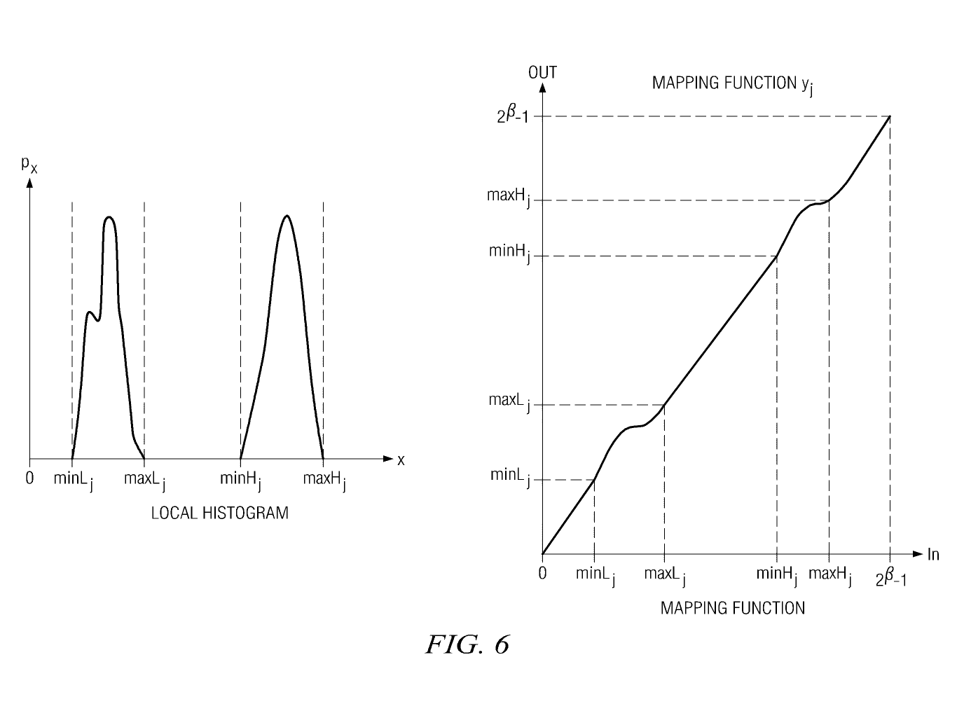

When an image includes a visually distinct dark portion and bright portion, e.g., the image has a dark object and bright background such as a shadowed building in front of a bright sky, the resulting histogram has two regions of clustered gray levels referred to as a bimodal distribution. This bimodal distribution could occur in both gray scale images and color images. FIG. 6 shows an example of a local histogram of a j-th sub-region with a bimodal distribution of gray levels. In one or more embodiments of the invention, to suppress inappropriate enhancement of the pixels in such a bimodal histogram, the above mapping function is applied to each portion of the histogram. The mapping function y for a bimodal histogram is expressed by:

$${y}_{j} = {T}_{j} ( x ) = \{ \begin{matrix}x & if x < {minL}_{j} or {maxL}_{j} < x < {minH}_{j} or {maxH}_{j} < x \\ f ( x ) \cdot {P}_{jx} \cdot ( {maxL}_{j} - {minL}_{j} ) + {minL}_{j} & if {minL}_{j} <= x <= {maxL}_{j} \\ f ( x ) \cdot {P}_{jx} \cdot ( {maxH}_{j} - {minH}_{j} ) + {minH}_{j} & if {minH}_{j} <= x <= {maxH}_{j}\end{matrix} \qquad ( 14 )$$

where minL, maxL, minH, and maxH denote the minimum value of the lower (darker) part, the maximum value of the lower part, the minimum value of the higher (lighter) part, and the maximum value of the higher part, respectively. FIG. 6 shows an example of the mapping function of equation 14 for a bimodal histogram of a j-th sub-region.

After local histogram equalization as described above, the dynamic range of the gray level in a sub-region is preserved. However, this preservation often has less effect on an image in which the dynamic range or brightness is low. Therefore, in one or more embodiments of the invention, when the dynamic range or brightness is low, the mapping function is gained slightly to expand the dynamic range and brightness. The gained mapping function Gⱼ(x) is expressed as:

Gⱼ(x)=Tⱼ(x)·g(maxⱼ), g(maxⱼ)=(log₁₀(2^{β}−1)−log₁₀(maxⱼ)+1) (15)

where g(maxⱼ) is the gain factor. Obviously, g(maxⱼ) is larger than 1 because 2^{β}−1≧maxⱼ so log₁₀(2^{β}−1)−log₁₀(maxⱼ) should be a positive value. The value of g(maxⱼ) increases as maxⱼ decreases, and g(maxⱼ) decreases to 1 as maxⱼ increases to 2^{β}−1, logarithmically. The effect is that the gray level of a darker region is gained to be lighter, and the lighter region is only slightly changed. Also, the dynamic range after the process is expanded by g(maxⱼ), that is, the dynamic range after the gained mapping function is applied, i.e., maxⱼ·g(maxⱼ)−minⱼ·g(maxⱼ)=(maxⱼ−minⱼ)·g(maxⱼ), should be larger than the dynamic range before the gained mapping function is applied, i.e., maxⱼ−minⱼ, because of g(maxⱼ)≧1 as described above. Additionally, the dynamic range of the darker region is more expanded than the lighter region because g(maxⱼ) of the darker region is larger than the lighter region as described above.

If the gained mapping function described above is applied to all sub-regions, excessive enhancement may occur. Therefore, in one or more embodiments of the invention, the gained mapping function is applied only to selected higher activity sub-regions. The activity of a sub-region, Act, is defined by the gradient (or 1^{st}-order derivative) operator and is expressed as:

$${Act}_{j} = {\sum }_{( s , t ) ∈ j} \{ \begin{matrix}\frac{1}{Ngh} \cdot \vert k ( s + 1 , t ) - k ( s , t ) \vert + \\ \frac{1}{Ngv} \cdot \vert k ( s , t + 1 ) - k ( s , t ) \vert\end{matrix} \} \qquad ( 16 )$$

where k(s,t) denotes the gray level of the pixel located at coordinates (s,t), and Ngh and Ngv denotes the total number of the horizontal and vertical gradient values of the j-th sub-region, respectively.

When the activity of a sub-region as determined using equation 16 exceeds an activity threshold, the gained mapping function is applied to the sub-region. In some embodiments of the invention, the activity threshold value used is the relational value between the local activity, i.e., Actⱼ and the global activity, i.e., Act_{global} of the image. This relational value, Rⱼ, is expressed by:

$${r}_{j} = ( {Act}_{j} / {Act}_{glabol} - 1 ) , \\ {R}_{j} = \{ \begin{matrix}0 & if {r}_{j} < 0 \\ {r}_{j} , & if {r}_{j} >= 0 and {r}_{j} <= 1 \\ 1 & otherwise\end{matrix} \qquad ( 17 )$$

where Act_{global} is the sum of the Actⱼ. Using Rⱼ, the gained mapping function in equation 15 can be expressed as:

Gⱼ(x)=Tⱼ(x)·gact(maxⱼ), gact(maxⱼ)=((log₁₀(2^{β}−1)−log₁₀(maxⱼ))·Rⱼ+1) (18)

Using this equation, if the local activity is smaller than the global activity, i.e., rⱼ<0, then gact(maxⱼ)=1, i.e., Gⱼ(x)=Zⱼ(x), and thus the mapping function has no effect. However, if the local activity is at least double the global activity, i.e., rⱼ>1, then gact(maxⱼ)=g(maxⱼ), i.e., Gⱼ(x)=Zⱼ(x)*g(maxⱼ), and the mapping functions is that of equation 15. And, if the local activity is larger than the global activity and twice the local activity is less than the global activity, i.e., Actⱼ>Act_{global} and 2*Actⱼ<Act_{global}, Zⱼ(x) is gained by gact(maxⱼ) which changes corresponding to the ratio of local and global activity. Thus, the gain factor of the gained mapping function can be changed corresponding to the ratio of the local and global activity; in fact, the contrast enhancement with the gained mapping function is applied to the desired region with weighting.

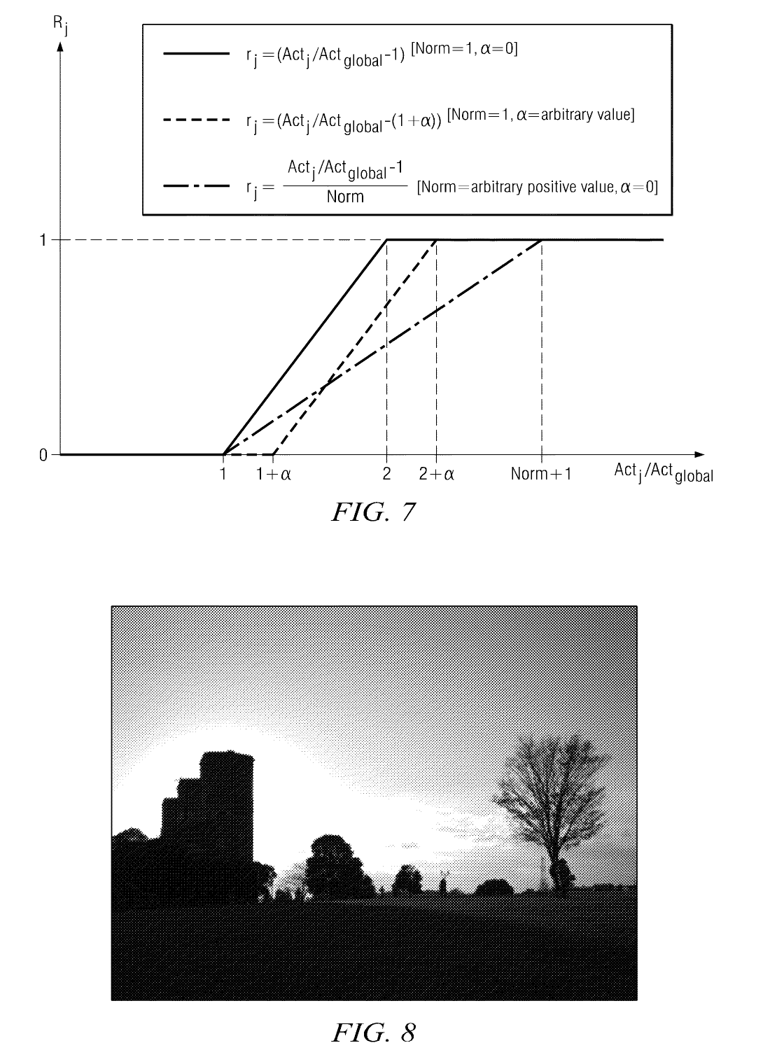

In one or more embodiments of the invention, the relational value is determined using adjustable parameters and is expressed as:

$$\begin{matrix}{r}_{j}^{′} = \frac{( {Act}_{j} / {Act}_{global} - ( 1 + α ) )}{Norm} , & \\ {R}_{j}^{′} = \{ \begin{matrix}0 & if {r}_{j}^{′} < 0 \\ {r}_{j}^{′} & if {r}_{j}^{′} >= 0 and {r}_{j}^{′} <= 1 \\ 1 & otherwise\end{matrix} & ( 19 )\end{matrix}$$

where Norm is an arbitrary positive number referred to as the normalization factor, and α is an arbitrary positive or negative number referred to as the offset factor. In one or more embodiments of the invention, the values of Norm and α are set by a user and/or may be assigned default values. FIG. 7 shows the ratio of global and local activity Actⱼ/Act_{global} versus the relational value Rⱼ. FIG. 7 shows that the value of α can shift the position of the slope, and the value of Norm can change the gradient of the slope. If a user wants to apply the gained mapping function to almost the whole image, the user can set a to a negative number. Further, if only large activity regions are desired, the value of α can be set to a large positive value. In addition, if Norm is set to a larger value, the activity level for the gained mapping function is wider and the gain factor is changed gradually corresponding to the activity.

When bimodal distribution is present, the gained mapping function of equation 18 for this case is expressed as:

$${G}_{j} ( x ) = \{ \begin{matrix}{GL}_{j} ( x ) = \begin{matrix}{ZL}_{j} ( x ) \cdot \\ gactL , gactL\end{matrix} = ( ( \begin{matrix}{log}_{10} ( min {H}_{j} \cdot γ ) - \\ {log}_{10} ( max {L}_{j} )\end{matrix} ) \cdot {RL}_{j} + 1 ) \\ {GH}_{j} ( x ) = \begin{matrix}{ZH}_{j} ( x ) \cdot \\ gactH , gactH\end{matrix} = ( ( \begin{matrix}{log}_{10} ( ( {2}^{β} - 1 ) ) - \\ {log}_{10} ( max {H}_{j} )\end{matrix} ) \cdot {RH}_{j} + 1 ) \end{matrix} , \\ \frac{max {L}_{j}}{min {H}_{j}} < γ < 1 \qquad ( 20 )$$

where GLⱼ(x) and GHⱼ(x), ZLⱼ(x) and ZHⱼ(x), and RLⱼ and RHⱼ denote the lower and higher parts of the gained mapping function, the mapping function, and the relational values, respectively and y is an arbitrary number that adjusts the impact of the gained mapping function. In one or more embodiments of the invention, the value of γ is set by a user and/or may be assigned a default value. In one or more embodiments of the invention, the value of γ is 0.9.

Experiments were performed to assess the performance of embodiments of the above described methods. The performance assessment was based on the subjective quality of the resulting images. In the experiments, the results of applying global histogram equalization and the results of the three methods for local histogram equalization described above (i.e., the mapping function without gain as expressed in equation 12, the gained mapping function without activity factor as expressed in equation 15, and the gained mapping function with activity factor as expressed in equation 19 with Norm=0.5 and α=−0.5) were compared. Here, note that the local histogram equalization is applied after global histogram equalization and the general processes for local histogram equalization, i.e., the connection to neighborhood blocks, overlapping, etc., common to the three methods are performed.

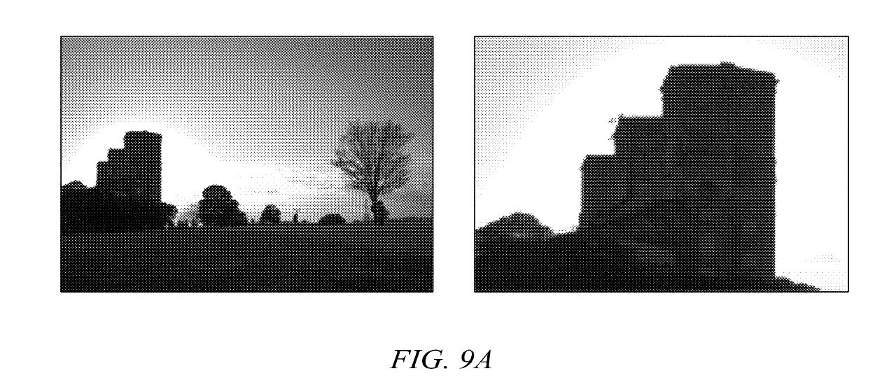

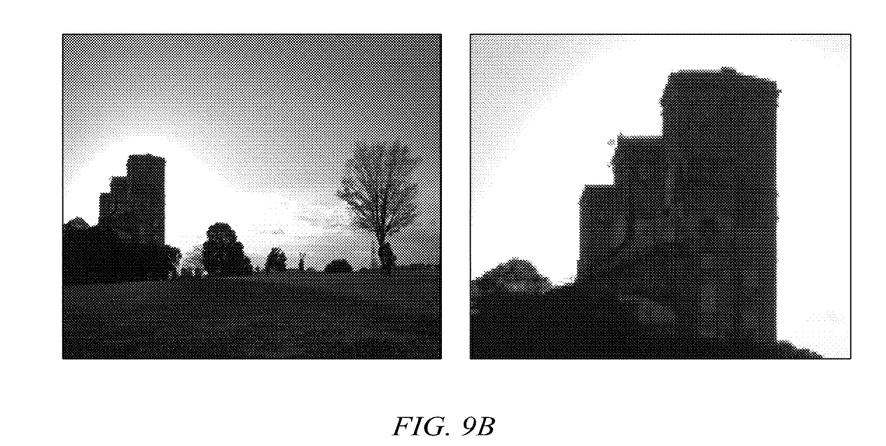

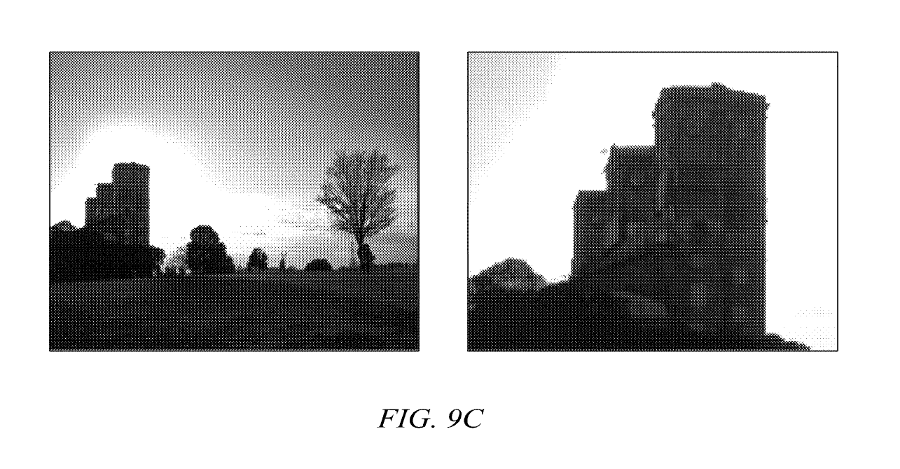

FIG. 8 shows the test image used for the experiments. FIG. 9A shows the test image after the application of global histogram equalization and FIGS. 9B-9D show the test image after the application of local histogram equalization without gain, gained without activity factor, and gained with activity factor, respectively. The right side images of FIGS. 9A-9D are magnified views of the building in the left side images. As can be seen by comparing FIG. 8 and FIG. 9A, global histogram equalization improves the image to even out the original biased histogram. FIG. 9B shows that local histogram equalization enhances the local contrast. However, the brightness of the right side image in FIG. 9B is low and it is difficult to see the enhanced contrast clearly. FIG. 9C shows that the brightness and contrast of the building is enhanced by the use of the gained mapping function. However, over-enhancement occurs in the sky. Finally, FIG. 9D shows that the activity factor for the gained mapping function helps to suppress the over-enhancement.

Local Contrast Enhancement with Low Resource Consumption

As was previously mentioned, histogram equalization, especially local histogram equalization, may require memory and processing resources at a level not appropriate for resource constrained devices. Accordingly, in one or more embodiments of the invention, a method for local contrast enhancement is used that does not require histogram equalization. This method is applied to an image after some form of global contrast enhancement (e.g., global HE) is applied.

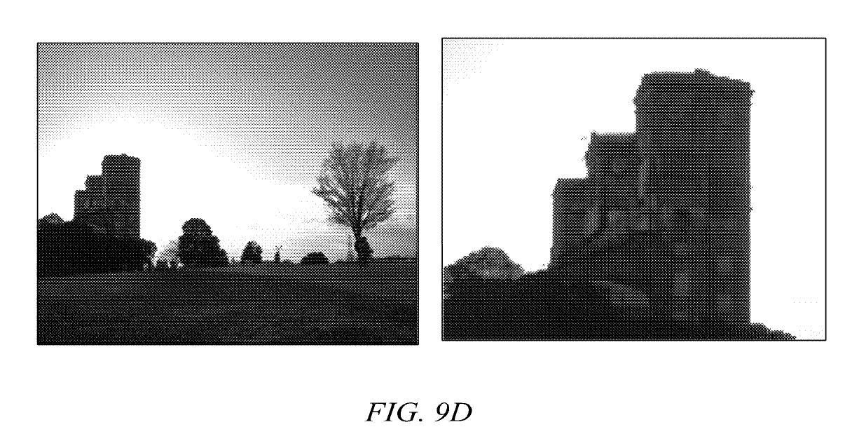

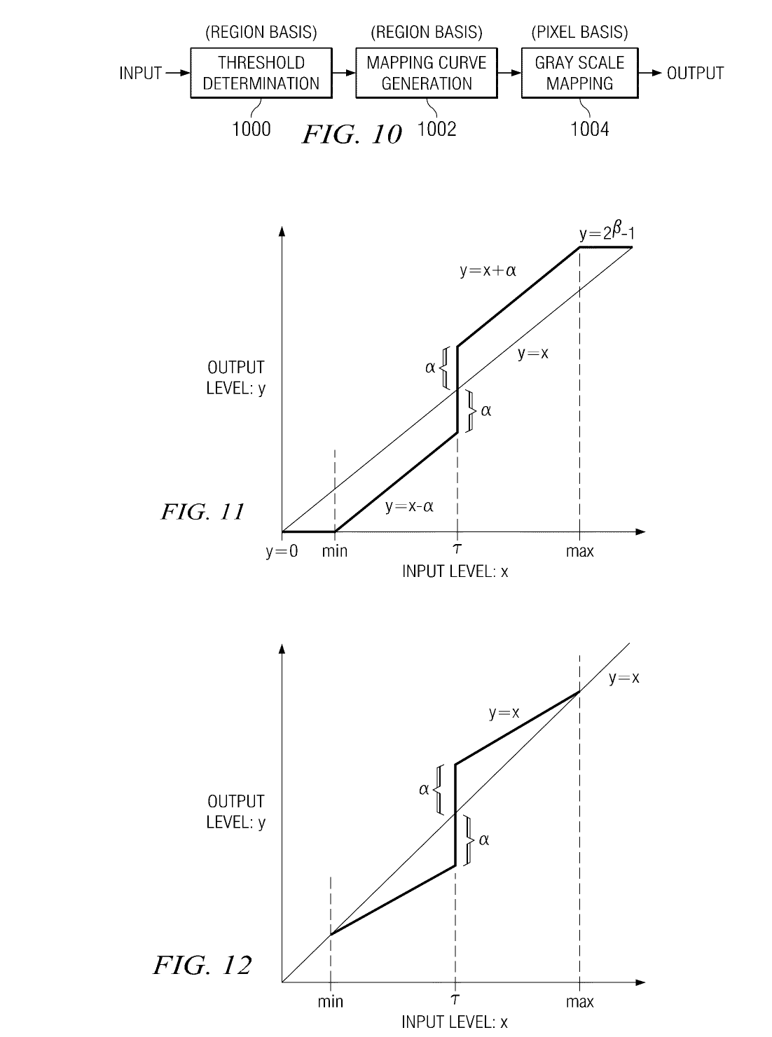

FIG. 10 shows a block diagram of a method for local contrast enhancement of an image in accordance with one or more embodiments of the invention. The image is divided into regions and the method is applied to each of the regions. In one or more embodiments of the invention, each region is 16 pixels by 16 pixels in size. First, a threshold gray value is determined for a region (1000) in the image. In some embodiments of the invention, the threshold gray value for a region, denoted by τ, is expressed as

τ=(max+min)/2 (21)

where max and min are the maximum and minimum grey values in the region, respectively. In other embodiments of the invention, the threshold gray value may be determined using other functions of max and min (e.g., the median). Pixels in the region may then be classified into two groups, a bright pixel group and a dark pixel group, based on the region threshold gray value. That is, pixels with a gray value above the threshold gray value are considered to be in the bright pixel group and pixels with a gray value below the threshold gray value are considered to be in the dark pixel group.

A mapping curve is also generated for the region in the form of y=M(x) that produces an output gray level y for each input gray level x in the region (1002). In one or more embodiments of the invention, a simple dislocation mapping curve is generated as illustrated in FIG. 11. The simple dislocation mapping is expressed by:

$${M}_{SD} ( x ) = \{ \begin{matrix}0 & if x <= α \\ x - α & else if x <= τ \\ x + α & else if x <= {2}^{β} - 1 - α \\ {2}^{β} - 1 & otherwise\end{matrix} \qquad ( 22 )$$

where the gray level modification parameter α can take any reasonable value. Experiments show that α=(max−min)/4 provides good results. In one or more embodiments of the invention, the value of the gray level modification parameter may be specified by a user and/or may be a default value.

In one or more embodiments of the invention, a dynamic range retained dislocation mapping curve is generated as illustrated in FIG. 12. This mapping curve retains the dynamic range of the region. The dynamic range retained dislocation mapping is expressed by:

$${M}_{DRRD} ( x ) = \{ \begin{matrix}\frac{1}{τ - min} \{ ( τ - min - α ) x + α \cdot min \} & if x <= τ \\ \frac{1}{max - τ} \{ ( max - τ - α ) x + α \cdot max \} & otherwise\end{matrix} \qquad ( 23 )$$

where the gray level modification parameter α is a value in the range 0<α<(max−min)/2. Experiments show that α=(max−min)/4 provides good results. In one or more embodiments of the invention, the value of the gray level modification parameter may be specified by a user and/or may be a default value.

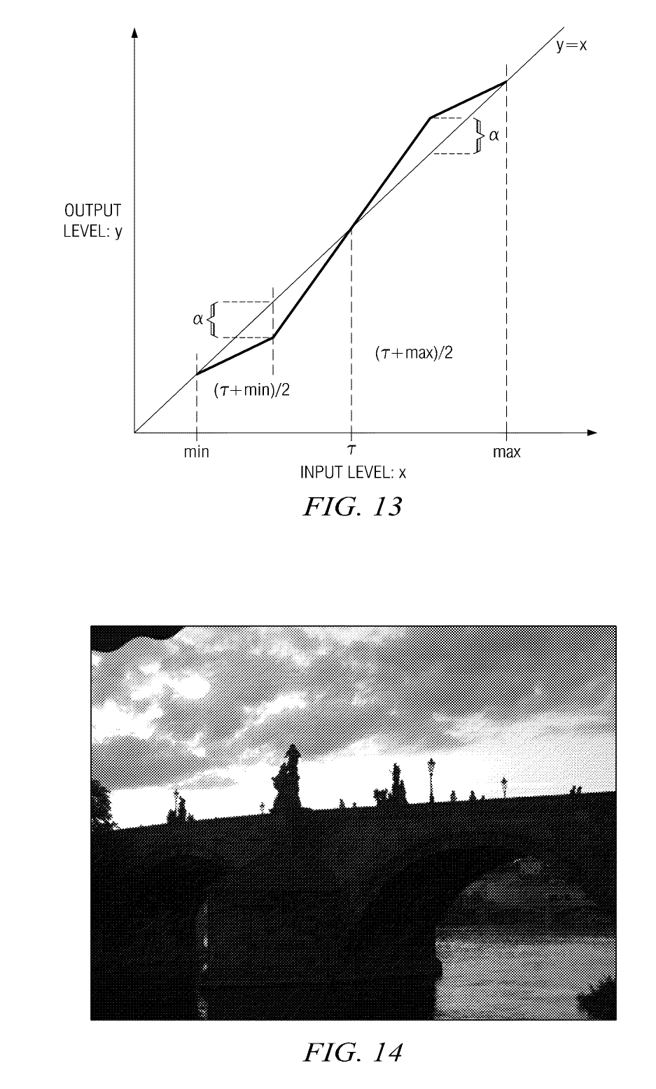

In one or more embodiments of the invention, a pseudo Gaussian mapping curve is generated as illustrated in FIG. 13. This mapping curve is designed to line-approximate a Gaussian like distribution curve. The mapping function is expressed by:

$${M}_{PG} ( x ) = \{ \begin{matrix}\frac{1}{max - min} \{ \begin{matrix}( max - min - 4 α ) \\ x + 4 α \cdot min\end{matrix} \} & if x <= ( τ + min / 2 ) \\ \frac{1}{max - min} \{ \begin{matrix}( max - min + 4 α ) \\ x - 2 α \cdot ( max - min )\end{matrix} \} & else if x <= ( τ + max / 2 ) \\ \frac{1}{max - min} \{ \begin{matrix}( max - min - 4 α ) \\ x + 4 α \cdot max\end{matrix} \} & otherwise\end{matrix} \qquad ( 24 )$$

where the gray level modification parameter α is a value in the range 0<α<(max−min)/4. Experiments show that α=(max−min)/4 provides good results. In one or more embodiments of the invention, the value of the gray level modification parameter may be specified by a user and/or may be a default value.

In other embodiments of the invention, other, more complex mapping curves may be generated that are more computationally intensive when appropriate computational resources are available.

Once the mapping curve M(x) is generated, gray scale mapping is performed on the pixels in the region (1004). The output gray level y for each pixel is obtained by applying the generated mapping curve to each pixel x as expressed by:

y=M(x) (25)

Experiments were performed to assess the performance of the method for local contrast enhancement using each of the three mapping curves. The performance assessment was based on the subjective quality of the resulting images. The assessment focused on how the method for local contrast enhancement using each of the three mapping curves affected the local contrast in comparison with the application of plain histogram equalization. Usually local processing such as local contrast enhancement necessitates boundary processing that allows smooth transition between adjacent regions. So, simple boundary processing was applied for fair comparison.

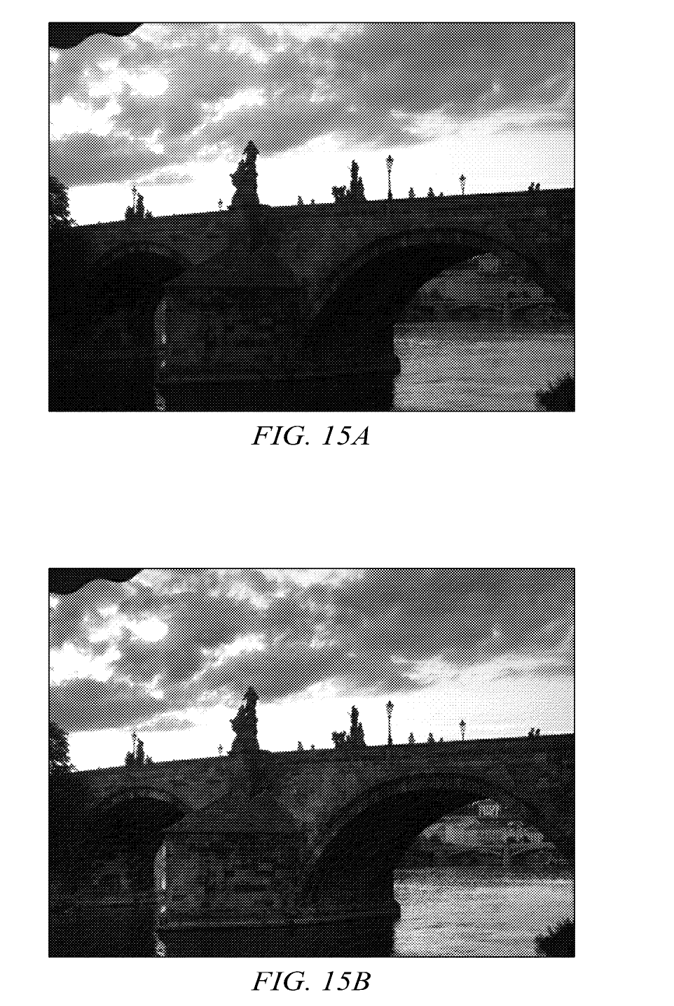

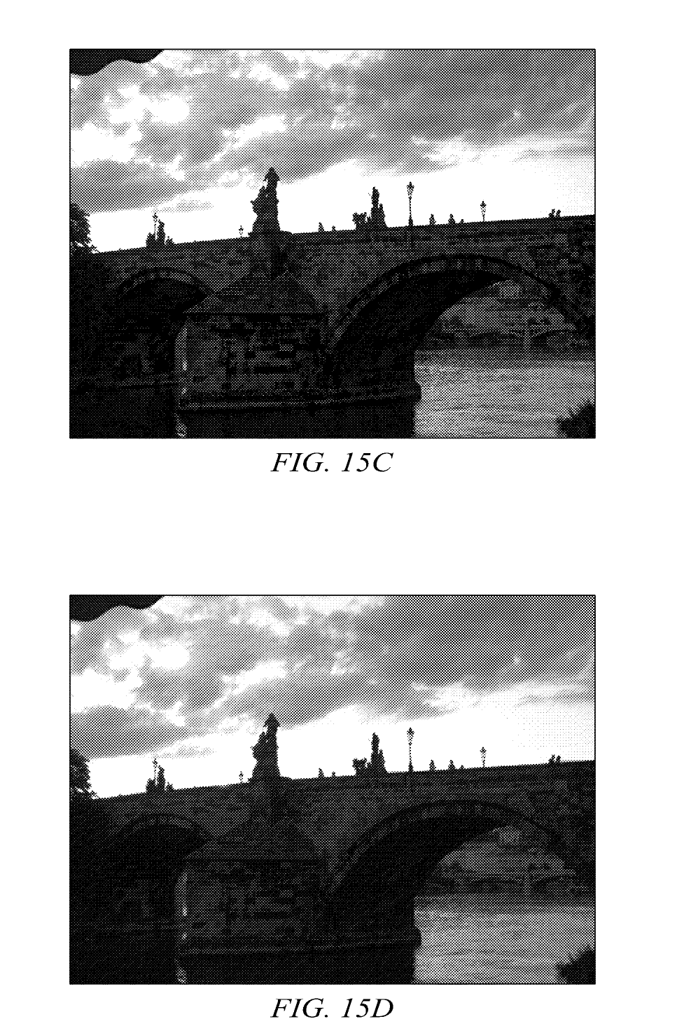

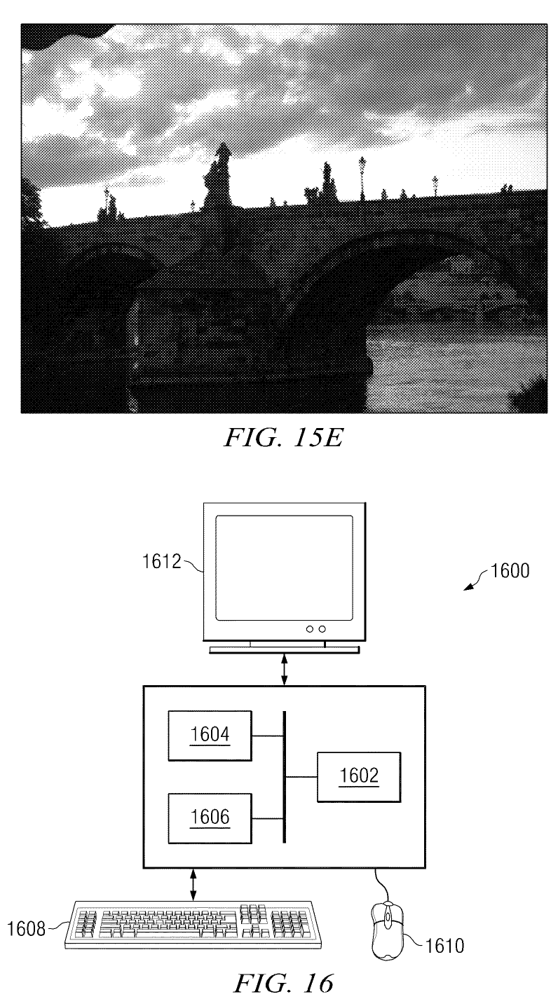

FIG. 14 shows the test image used in the experiments. This test image is 800 by 600 pixels and is characterized with under exposure which results in a narrow dynamic range that concentrates on the dark side. FIG. 15A shows the test image after the application of global contrast enhancement. In the experiments, a plain HE based global contrast enhancement was used. This test image is used as the input for the local contrast enhancement method with each of the three mapping curves. FIG. 15B shows the test image after the application of global histogram equalization. FIGS. 15C-15E show the test image after the application of the local contrast enhancement method with the simple dislocation mapping curve, the dynamic range retained dislocation mapping curve, and the pseudo Gaussian mapping curve, respectively. In the experiments, the value of the parameter α was set to (max−min)/4 and the region size used was 16 by 16 pixels.

Overall, result of applying the global histogram equalization and the local contrast enhancement method with each of the three mapping curves improved the original test image in the sense that objects can be identified more clearly. Among the three mapping curves, the simple dislocation mapping curve gives better local contrast enhancement than the others, but looks somewhat synthetic, hence, unnatural. The dynamic range retention type mapping curves, i.e., the dynamic range retained dislocation and the pseudo Gaussian, mostly affect the image tone conservatively. However, it is noteworthy that these dynamic range retention type mapping curves yield fairly good images without having to apply boundary processing whilst the simple dislocation type mapping curve and the global histogram equalization require some boundary processing.

Embodiments of the methods and systems for contrast enhancement described herein may be implemented for virtually any type of digital system (e.g., a desk top computer, a laptop computer, a handheld device such as a mobile (i.e., cellular) phone, a personal digital assistant, a digital camera, etc.) with functionality to capture and/or process digital images. For example, as shown in FIG. 16, a digital system (1600) includes a processor (1602), associated memory (1604), a storage device (1606), and numerous other elements and functionalities typical of today's digital systems (not shown). In one or more embodiments of the invention, a digital system may include multiple processors and/or one or more of the processors may be digital signal processors. The digital system (1600) may also include input means, such as a keyboard (1608) and a mouse (1610) (or other cursor control device), and output means, such as a monitor (1612) (or other display device). The digital system (1600) may also include an image capture device (not shown) that includes circuitry (e.g., optics, a sensor, readout electronics) for capturing digital images. The digital system (1600) may be connected to a network (1614) (e.g., a local area network (LAN), a wide area network (WAN) such as the Internet, a cellular network, any other similar type of network and/or any combination thereof) via a network interface connection (not shown). Those skilled in the art will appreciate that these input and output means may take other forms.

Further, those skilled in the art will appreciate that one or more elements of the aforementioned digital system (1600) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, or any other computer readable storage device. The software instructions may be distributed to the digital system (1600) via removable memory (e.g., floppy disk, optical disk, flash memory, USB key), via a transmission path (e.g., applet code, a browser plug-in, a downloadable standalone program, a dynamically-linked processing library, a statically-linked library, a shared library, compilable source code), etc.

Embodiments of the methods described herein can be useful for enhancing or improving several types of images. Further, embodiments of the method may be applied to images as they are captured (e.g., by a digital camera or scanner), as part of a photoprocessing application or other application with image processing capability executing on a computer, and/or when the images are printed (e.g., in a printer as part of preparing to print the images). Embodiments of the methods may also be implemented as part of a device driver (e.g., a printer driver or display driver), so that the driver performs correction on an image before the image is displayed or printed.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method for contrast enhancement of a digital image, the method comprising:
dividing a region of pixels in the digital image into a plurality of sub-regions;
determining a weighting factor for each sub-region of the plurality of sub-regions;
generating an accumulated normalized histogram of gray level counts in the region wherein for each sub-region, the weighting factor for the sub-region is applied to gray level counts in the sub-region; and
applying a mapping function based on the accumulated normalized histogram to the pixels in the region to enhance contrast, wherein the mapping function produces an equalized gray level for each pixel in the region.

2. The method of claim 1, wherein generating an accumulated normalized histogram further comprises computing
$$\frac{1}{W} {\sum }_{j = 0}^{M - 1} {\sum }_{i = 0}^{x} {p}_{ij}$$
wherein
$${p}_{ij} = \frac{{w}_{ij} \cdot {n}_{ij}}{{n}_{j}} , i ∈ 0 , 1 , … , {2}^{β} - 1$$
and
$$W = {\sum }_{j = 0}^{M - 1} {w}_{j} ,$$
wherein M denotes a number of sub-regions in the plurality of sub-regions, wⱼ denotes the weighting factor of a j-th sub-region, nᵢⱼ denotes a number of occurrences of a gray level i in j-th sub-region, nⱼ denotes a total number of pixels in the j-th sub-region, β denotes a number of bits per pixel, and x is a gray level.

3. The method of claim 1, wherein determining a weighting factor further comprises computing the weighting factor as a difference between a maximum gray level and a minimum gray level in the sub-region.

4. The method of claim 1, wherein determining a weighting factor further comprises computing the weighting factor based on a variance of gray levels in the sub-region.

5. The method of claim 1, wherein determining a weighting factor further comprises computing the weighting factor based on entropy of the sub-region.

6. The method of claim 1, wherein determining a weighting factor further comprises computing the weighting factor based on at least one gradient of the sub-region.

7. A method for contrast enhancement of a digital image, the method comprising:
dividing a region of pixels in the digital image into a plurality of sub-regions;
generating an accumulated normalized histogram of gray level counts for a sub-region; and
applying a first mapping function based on the accumulated normalized histogram to the pixels in the sub-region to enhance contrast,
wherein the first mapping function changes a gray level of a pixel only when the gray level is between or equal to a maximum gray level and a minimum gray level,
wherein the maximum gray level and the minimum gray level are one selected from a group consisting of a maximum gray level of the sub-region and a minimum gray level of the sub-region, and a weighted average of the maximum gray level of the sub-region and maximum gray levels of neighboring sub-regions and a weighted average of the minimum gray level of the sub-region and minimum gray levels of neighboring sub-regions.

8. The method of claim 7, further comprising:
when the maximum gray level and the minimum gray level are the maximum gray level and the minimum gray level of the sub-region, computing the first mapping function Tⱼ(x) as
$${T}_{j} ( x ) = \{ \begin{matrix}x & if x < {min}_{j} or {max}_{j} < x \\ f ( x ) \cdot {P}_{jx} \cdot ( {max}_{j} - {min}_{j} ) + {min}_{j} & if {min}_{j} <= x <= {max}_{j}\end{matrix}$$
wherein x denotes a gray level, f(x) denotes a cumulation function, j denotes an index of the sub-region, maxⱼ denotes the maximum gray level of the sub-region, minⱼ denotes the minimum gray level of the sub-region, Pⱼₓ denotes the accumulated normalized histogram of the sub-regions and is computed as
$${P}_{jx} = {\sum }_{i = 0}^{x} {p}_{ij}$$
wherein pᵢⱼ is the probability of an occurrence of a pixel of gray level i in the sub-region; and
when the maximum gray level and the minimum gray level are the weighted averages, computing the first mapping function Tⱼ(x) as,
$${y}_{i} = {T}_{j} ( x ) = \{ \begin{matrix}x & if x < \overline{{min}_{j}} or \overline{{max}_{j}} < x \\ f ( x ) \cdot {P}_{jx} \cdot ( \overline{{max}_{j}} - \overline{{min}_{j}} ) + \overline{{min}_{j}} & if \overline{{min}_{j}} <= x <= \overline{{max}_{j}}\end{matrix}$$
wherein m̅a̅x̅ⱼ̅ denotes the weighted average of the maximum gray level of the sub-region and maximum gray levels of neighboring sub-regions, and m̅i̅n̅ⱼ̅ denotes the weighted average of the minimum gray level of the sub-region and minimum gray levels of neighboring sub-regions.

9. The method of claim 7, further comprising:
when the accumulated normalized histogram comprises a bimodal distribution comprising first cluster of gray levels and a second cluster of gray levels,
applying a second mapping function based on the accumulated normalized histogram to the pixels having gray levels in the first cluster, wherein the second mapping function changes a gray level of a pixel only when the gray level is between or equal to a maximum gray level of the first cluster and a minimum gray level of the first cluster; and
applying a third mapping function based on the accumulated normalized histogram to the pixels having gray levels in the first cluster, wherein the third mapping function changes a gray level of a pixel only when the gray level is between or equal to a maximum gray level of the second cluster and a minimum gray level of the second cluster.

10. The method of claim 7, wherein the first mapping function is further based on a gain factor for the sub-region, wherein the gain factor g(maxⱼ) is computed as
g(maxⱼ)=(log₁₀(2^{β}−1)−log₁₀(maxⱼ)+1)
wherein j denotes an index of the sub-region, maxⱼ denotes the maximum gray level of the sub-region, and β denotes a number of bits per pixel.

11. The method of claim 10, further comprising:
determining an activity factor for the sub-region based on a total number of horizontal gradients in the sub-region and a total number of vertical gradients in the sub-region, and
wherein the first mapping function is further based on the gain factor only when the activity factor exceeds an activity threshold.

12. The method of claim 11, wherein the activity threshold is a relational value between the activity factor of the sub-region and an activity factor of the region, wherein the activity of the region is based on a total number of horizontal gradients in the region and a total number of vertical gradients in the region.

13. The method of claim 12, wherein the relational value is based on an offset factor and is normalized by a normalization factor.

14. The method of claim 9,
wherein the second mapping function is further based on a gain factor gactL for the first cluster, wherein the gain factor gactL is computed as
gactL=((log₁₀(minHⱼ·γ)−log₁₀(maxLⱼ))·RLⱼ+1
wherein j denotes an index of the sub-region, minHⱼ denotes the minimum gray level of the second cluster, maxLⱼ denotes the maximum gray level of the first cluster, β denotes a number of bits per pixel, and RLⱼ is an activity threshold of the first cluster, and
wherein the third mapping function is further based on a gain factor gactH for the second cluster, wherein the gain factor gactH is computed as
gactH=((log₁₀((2^{β}−1))−log₁₀(maxHⱼ))·RHⱼ+1)
wherein RHⱼ is an activity threshold of the second cluster, and
wherein
$$\frac{max {L}_{j}}{min {H}_{j}} < γ < 1.$$

15. A method for contrast enhancement of a digital image, the method comprising:
dividing the digital image into a plurality of regions of pixels; and
for each region in the plurality of regions,
determining a threshold gray level for the region;
generating a mapping curve M(x) for the region based on the threshold gray level; and
applying the generated mapping curve to each pixel in the region to enhance contrast.

16. The method of claim 15, wherein determining a threshold gray level further comprises computing the threshold gray level as one half of the sum of the maximum gray level in the region and the minimum gray level in the region.

17. The method of claim 15, wherein the mapping curve M(x) for each pixel x in the region is generated as
$${M}_{SD} ( x ) = \{ \begin{matrix}0 & if x <= α \\ x - α & else if x <= τ \\ x + α & else if x <= {2}^{β} - 1 - α \\ {2}^{β} - 1 & otherwise\end{matrix}$$
wherein τ denotes the threshold gray level, α denotes a gray level modification parameter, β denotes the number of bits per pixel, and 2^{β} denotes a total number of gray levels in the region.

18. The method of claim 15, wherein the mapping curve M(x) for each pixel x in the region is generated as
$${M}_{DRRD} ( x ) = \{ \begin{matrix}\frac{1}{τ - min} \{ ( τ - min - α ) x + α \cdot min \} & if x <= τ \\ \frac{1}{max - τ} \{ ( max - τ - α ) x + α \cdot max \} & otherwise\end{matrix}$$
wherein τ denotes the threshold gray level and α denotes a gray level modification parameter having a value in a range 0≦α≦(max−min)/2 wherein max denotes a maximum gray level in the region and min denotes a minimum gray level in the region.

19. The method of claim 15, wherein the mapping curve M(x) for each pixel x in the region is generated as
$${M}_{PG} ( x ) = \{ \begin{matrix}\frac{1}{max - min} \{ \begin{matrix}( max - min - 4 α ) \\ x + 4 α \cdot min\end{matrix} \} & if x <= ( τ + min / 2 ) \\ \frac{1}{max - min} \{ \begin{matrix}( max - min + 4 α ) \\ x - 2 α \cdot ( max - min )\end{matrix} \} & else if x <= ( τ + max / 2 ) \\ \frac{1}{max - min} \{ \begin{matrix}( max - min - 4 α ) \\ x + 4 α \cdot max\end{matrix} \} & otherwise\end{matrix}$$
wherein τ denotes the threshold gray level and α denotes a gray level modification parameter having a value in a range 0≦α≦(max−min)/4 wherein max denotes a maximum gray level in the region and min denotes a minimum gray level in the region.
